(19) United States
(12) Patent Application Publication
(10) Pub. No.: US 2010/0266724 A1
(43) Pub. Date: Oct. 21, 2010

(54) METHOD FOR PRODUCING AN ACIDIFIED MILK DRINK

(75) Inventors: Jeppe Wegener Tams, Gentofte (DK); Preben Nielsen, Hoersholm (DK); Kirk Matthew Schnorr, Holte (DK)

Correspondence Address: NOVOZYMES NORTH AMERICA, INC., 500 FIFTH AVENUE, SUITE 1600, NEW YORK, NY, 10110, US

(73) Assignees: Novozymes A/S, Bagsvaerd (DK); Chr. Hansen A/S, Hoersholm (DK)

(21) Appl. No.: 12/678,384

(22) PCT Filed: Sep. 16, 2008
(86) PCT No.: PCT/EP08/62299

§ 371 Date: Jun. 2, 2010

Related U.S. Application Data
(60) Provisional application No. 60/973,607, filed on Sep. 19, 2007.

(30) Foreign Application Priority Data
Sep. 18, 2007 (EP) 07116684.7

(51) Int. Cl. A23C 9/12

(52) U.S. Cl. 426/42; 426/580

(57) ABSTRACT

The present invention relates to a method for producing an acidified milk drink using an enzyme having phenoloxidase activity.

### SEQUENCE LISTING

The present invention comprises a sequence listing.

### TECHNICAL FIELD

The present invention relates to a method for producing an acidified milk drink using an enzyme having phenol oxidase activity.

### BACKGROUND OF THE INVENTION

The market for acidified milk drinks, which includes fermented milk drinks and liquid yoghurt, is increasing worldwide and there is an interest in improving the quality and economics of this product.

Acidified milk drinks are generally produced by mixing acidified milk with a sugar syrup solution, and subjecting the mixture to a homogenization treatment. Acidification may take place through addition of a chemical, such as glucono delta-lactone (GDL), or it may be caused by fermentation of the milk with lactic acid bacteria. When such products are stored, however, casein, a component of milk, often precipitates or associates and aggregates, and as a result the drinks tend to separate so that liquid whey collects on the surface. This process, which is often referred to as syneresis, decreases the quality of the acidified milk drinks.

Pectin, starch, modified starch, CMC, etc., are often used as stabilizers in acidified milk drinks, but due to the relatively high cost of such stabilizers, there is an interest in finding other and perhaps even better solutions. It is therefore an object of the present invention to provide a method for manufacturing of a stable acidified milk drink where the separation into curd and whey upon storage is reduced. The aim is to provide an alternative method for stabilization to replace or eliminate, at least partly, the use of the stabilizers used in the art today.

The use of enzymes having phenol oxidase activity for modification of food proteins, including dairy proteins, is known in the prior art. For instance, WO2006/084953 discloses novel fungal tyrosinases and suggests their possible use for improvement of texture and rheological properties of food products, e.g. for gelling and reduction of syneresis in yoghurt.

In this publication, the hardness of a caseinate gel is reported to be doubled upon treatment with an enzyme having tyrosinase activity. US 2002/0009779 discloses use of multi-copper oxidase such as laccase to produce gelled protein having new physical properties and characteristics. Substrate proteins include milk protein such as casein, and in general a solution of increased viscosity or a precipitate is obtained when the protein concentration is low, and a gelled product can be obtained satisfactorily when the protein concentration is 1% by weight or more.

### SUMMARY OF THE INVENTION

The present inventors have surprisingly found that syneresis of acidified milk drinks can be decreased by adding an enzyme having phenol oxidase activity during the manufacture of the product.

Consequently, the present invention relates to a method for producing an acidified milk drink, said method comprising:

a) acidifying a milk substrate comprising milk protein; and
b) treating with an enzyme having phenol oxidase activity;
wherein step b) is performed before, during or after step a).

### DETAILED DISCLOSURE OF THE INVENTION

### Acidified Milk Drinks

“Acidified milk drinks” according to the present invention include any drinkable products based on acidified milk substrates which can be produced according to the method of the invention. Acidification may take place because of addition of a chemical, such as lactic acid, citric acid or glucono delta-lactone (GDL), or it may be as a fermentation with a microorganism. Acidified milk drinks thus include fermented milk drinks and liquid yoghurt drinks.

Acidified milk drinks according to the invention are drinkable in the sense that they are in liquid form and consumed as beverages, i.e. they are suitable for drinking. “In liquid form” means that the products are in the fluid state of matter thus exhibiting a characteristic readiness to flow. Thus, the shape of a liquid is usually determined by the container it fills, in contrary to, e.g., a gel-like substance, which is soft but not free flowing, such as e.g. yoghurt or pudding. “In liquid form” may also mean that the products are suitable for drinking using a straw, such as by suction through a straw having a length of 20-25 cm and a diameter of about 0.3 to 0.5 cm.

An acidified milk drink according to the present invention may have a viscosity which is lower than 40 Pa (obtained at shear rate 300 pr·s), preferable less than 30 Pa, more preferably less than 20 Pa, and even more preferably between 15 and 20 Pa at a shear rate of 300 pr·s.

Viscosity of acidified milk drinks may be determined as follows:

Principle: This method is based on characterisation of texture by a viscometry measurement (constant rate). Selected and calculated parameters from the flow curves are extracted.
Materials: StressTech rheometer (Rheologica Instruments, Lund, Sweden) with CC 25 (bop/cup) measurement system.
Procedure: Before the measurements are started, the samples must be tempered to the right temperature at 13° C.

A flow curve is registered by increasing the deformation (shear rate: 0.2707 to 300 s⁻¹) followed by a decreasing of deformation (shear rate: 300 to 0.2707 s⁻¹).

### Settings:

### Normal Force:

Method: To Gab
Max loading force: 10N
Start measurement when normal force is below: 10N
Time out: 1000 sec.
Approx. sample height: 1.000 mm

### Shear Rate:

21 steps—up and down: 0.2707-0.3304-0.4923-0.7334-1-2-4-6-10-25-50-75-100-125-150-175-200-225-250-275-300.
Delay time: 5 sec.
Integration time: 10 sec.

### Temperature and Time:

Equilibrium time: −
Manual: 1 repetition
Manual control: 13° C.
Temp. after measurement: 13° C.

### Advanced Position:

Position resolution: 85 y rad
Approach to steady state, interval+−: 0.010
Strength: 60%
Reference curve: off

An acidified milk drink according to the present invention may have a pH of less than 4.6, preferably less than 4.4, more preferably less than 4.2 and even more preferably about pH 4 or less. In one aspect, the acidified milk drink has a pH of less than 3.8, preferably less than 3.6.

An acidified milk drink according to the invention may have a fat content of 0 to 2%, preferably below 1.5%, below 1% or below 0.5%, more preferably of about 0.1% or less. The acidified milk drink may have a milk solid non-fat content of less than 20%, preferably less than 8.5%, less than 8%, less than 7.5%, less than 7%, less than 6.5%, or less than 6%, and more preferably of about 5%.

An acidified milk drink according to the invention may have a shelf life of more than 7 days, preferably more than 14 days, more preferably more than 28 days, and even more preferably more than 3 months.

Preferably, the acidified milk drink according to the present invention has an increased stability. The stability may be determined after having stored the acidified milk drink for an appropriate number of days by measuring the height of the whey collecting on the surface because of syneresis. It may also be determined after accelerated syneresis, such as by centrifugation.

### Method of Producing an Acidified Milk Drink

As mentioned above, the method for producing an acidified milk drink according to the present invention comprises:

a) acidifying a milk substrate comprising milk protein; and
b) treating with an enzyme having phenol oxidase activity;
wherein step b) is performed before, during or after step a).

“Milk substrate”, in the context of the present invention, may be any raw and/or processed milk material that can be subjected to acidification according to the method of the invention. Thus, useful milk substrates include, but are not limited to solutions/suspensions of any milk or milk like products comprising milk protein, such as whole or low fat milk, skim milk, buttermilk, reconstituted milk powder, condensed milk, dried milk, whey, whey permeate, lactose, mother liquid from crystallization of lactose, whey protein concentrate, or cream. Obviously, the milk substrate may originate from any mammal.

Preferably, the milk substrate is a lactose solution/suspension, and more preferably, the substrate is milk. In a preferred embodiment, the milk substrate is an aqueous solution of skim milk powder.

The milk substrate comprises milk protein, e.g. casein and/or whey protein. “Milk protein” in the context of the present invention may be any protein naturally occurring in milk. In a preferred embodiment, the milk protein is casein.

The term “milk” is to be understood as the lacteal secretion obtained by milking any mammal, such as cows, sheep, goats, buffaloes or camels.

In one embodiment, the milk substrate may be more concentrated than raw milk and it may thus have a protein content of more than 5%, preferably more than 6%, more than 7%, more than 8%, more than 9%, or more than 10%, and a lactose content of more than 7%, preferably more than 8%, more than 9%, or more than 10%.

Prior to acidification, the milk substrate may be homogenized and pasteurized according to methods known in the art.

“Homogenizing” as used herein means intensive mixing to obtain a soluble suspension or emulsion. If homogenization is performed prior to acidification, it may be performed so as to break up the milk fat into smaller sizes so that it no longer separates from the milk. This may be accomplished by forcing the milk at high pressure through small orifices.

“Pasteurizing” as used herein means heating to a specified temperature and maintaining at that temperature for a specified period of time. Such specified temperature may be at least 65° C., preferably at least 70° C. or at least 80° C. The specified time may be short, such as 15-20 seconds, or it may be longer, e.g., 10 minutes, 20 minutes or 30 minutes. Pasteurizing as used herein also encompasses UHT (ultra-high temperature) treatment, such as holding the milk substrate at a temperature of 138° C. for a fraction of a second The temperature and time may be selected in order to reduce or eliminate the presence of live organisms, such as harmful bacteria, and/or denature or partly denature the whey protein in the milk substrate.

In the method of the present invention, the milk substrate is acidified. Such acidification may be a chemical acidification, such as by the addition of an acid, such as lactic acid or citric acid. In a preferred embodiment, step a) comprises chemical acidification using glucono delta-lactone (GDL), which is a cyclic ester of D-gluconic acid commonly used for acidification of food.

The milk substrate may also be acidified by combined use of fermentation and chemical acidification.

In a preferred aspect of the method of the invention, the acidification takes place because of fermentation of the milk substrate with a microorganism.

“Fermentation” in the method of the present invention means the conversion of carbohydrates into alcohols or acids through the action of a microorganism. Preferably, fermentation in the method of the present invention comprises conversion of lactose to lactic acid.

In the context of the present invention, “microorganism” may include any bacterium or fungus being able to ferment the milk substrate. In a preferred embodiment, the microorganism is a lactic acid bacterium.

The microorganisms used for most fermented milk products are selected from the group of bacteria generally referred to as lactic acid bacteria. As used herein, the term “lactic acid bacterium” designates a gram-positive, microaerophilic or anaerobic bacterium, which ferments sugars with the production of acids including lactic acid as the predominantly produced acid, acetic acid and propionic acid. The industrially most useful lactic acid bacteria are found within the order “Lactobacillales” which includes Lactococcus spp., Streptococcus spp., Lactobacillus spp., Leuconostoc spp., Pseudoleuconostoc spp., Pediococcus spp., Brevibacterium spp., Enterococcus spp. and Propionibacterium spp. Additionally, lactic acid producing bacteria belonging to the group of the strict anaerobic bacteria, bifidobacteria, i.e. Bifidobacterium spp., which are frequently used as food cultures alone or in combination with lactic acid bacteria, are generally included in the group of lactic acid bacteria.

Lactic acid bacteria are normally supplied to the dairy industry either as frozen or freeze-dried cultures for bulk starter propagation or as so-called “Direct Vat Set” (DVS) cultures, intended for direct inoculation into a fermentation vessel or vat for the production of a dairy product, such as an acidified milk drink. Such cultures are in general referred to as “starter cultures” or “starters”.

Commonly used starter culture strains of lactic acid bacteria are generally divided into mesophilic organisms having optimum growth temperatures at about 30° C. and thermophilic organisms having optimum growth temperatures in the range of about 40 to about 45° C. Typical organisms belonging to the mesophilic group include Lactococcus lactis, Lactococcus lactis subsp. cremoris, Leuconostoc mesenteroides subsp. cremoris, Pseudoleuconostoc mesenteroides subsp. cremoris, Pediococcus pentosaceus, Lactococcus lactis subsp. lactis biovar. diacetylactis, Lactobacillus casei subsp. casei and Lactobacillus paracasei subsp. paracasei. Thermophilic lactic acid bacterial species include as examples Streptococcus thermophilus, Enterococcus faecium, Lactobacillus delbrueckii subsp. lactis, Lactobacillus helveticus, Lactobacillus delbrueckii subsp. bulgaricus and Lactobacillus acidophilus.

Also the strict anaerobic bacteria belonging to the genus Bifidobacterium including Bifidobacterium bifidum and Bifidobacterium longum are commonly used as dairy starter cultures and are generally included in the group of lactic acid bacteria. Additionally, species of Propionibacteria are used as dairy starter cultures, in particular in the manufacture of cheese. Additionally, organisms belonging to the Brevibacterium genus are commonly used as food starter cultures.

Another group of microbial starter cultures are fungal cultures, including yeast cultures and cultures of filamentous fungi, which are particularly used in the manufacture of certain types of cheese and beverage. Examples of fungi include Penicillium roqueforti, Penicillium candidum, Geotrichum candidum, Torula kefir, Saccharomyces kefir and Saccharomyces cerevisiae.

In a preferred embodiment of the present invention, the microorganism used for fermentation of the milk substrate is Lactobacillus casei or a mixture of Streptococcus thermophilus and Lactobacillus delbrueckii subsp. bulgaricus.

Fermentation processes to be used in production of acidified milk drinks are well known and the person of skill in the art will know how to select suitable process conditions, such as temperature, oxygen, amount and characteristics of microorganism/s, additives such as e.g. carbohydrates, flavours, minerals, enzymes (e.g. rennet and phospholipase) and process time. Obviously, fermentation conditions are selected so as to support the achievement of the present invention, i.e. to obtain a fermented milk product suitable in the production of an acidified milk drink.

In one embodiment of the method of the present invention, a syrup is added to the milk substrate, either before or after acidification.

In a preferred embodiment, a syrup is added to the milk substrate after acidification, such as after fermentation.

“Syrup” in the context of the present invention is any additional additive ingredient giving flavour and/or sweetness to the final product, i.e. the acidified milk drink. It may be a solution comprising, e.g., sugar, sucrose, glucose, liquid sugar of fructose, aspartame, sugar alcohol, fruit concentrate, orange juice, strawberry juice, apple juice, pineapple juice and/or lemon juice. The pH of the syrup may have been adjusted, e.g. to the same pH as the acidified milk substrate.

The mixture of the acidified milk substrate and the syrup may be homogenized using any method known in the art. The homogenization may be performed so as to obtain a liquid homogenous solution which is smooth and stable. Homogenization of the mixture of the acidified milk substrate and the syrup may be performed by any method known in the art, such as by forcing the milk at high pressure through small orifices.

In one embodiment of the invention, water is added to the acidified milk substrate, such as to the fermented milk substrate, and the mixture of acidified milk substrate, such as fermented milk substrate, and water is homogenized.

In another embodiment of the method of the invention, the acidification of the milk substrate takes place because of addition of the syrup, which may be acidic, i.e. by mixing the milk substrate with syrup in the form of, e.g., fruit concentrate, orange juice, strawberry juice and/or lemon juice.

Step b) of the method of the present invention comprises an enzyme treatment. The enzyme treatment may be performed prior to step a), i.e. the milk substrate may be subjected to enzyme treatment before acidification, such as before addition of the chemical acidifier or before inoculation with the microorganism. The enzyme treatment may be performed during step a), i.e. the milk substrate may be subjected to enzyme treatment at the same time as it is being acidified. In one embodiment, the enzyme is added before or after inoculation of the milk substrate with a microorganism, and the enzyme reaction on the milk substrate takes place at the same time as it is being fermented.

Alternatively, the enzyme treatment may be performed after step a), i.e. the milk substrate may be subjected to enzyme treatment after acidification. If the acidified milk substrate is mixed and optionally homogenized with the syrup, the enzyme treatment may be performed before or after this. The enzyme may be added at the same time or after the syrup, but before homogenization, or it may be added after the acidified milk substrate and the syrup have been mixed and homogenized.

In a preferred embodiment, step b) is performed before or during step a). In a more preferred embodiment, the milk substrate is subjected to pasteurization prior to step a), and the enzyme treatment is performed prior to pasteurization.

The enzyme having phenol oxidase activity is added in a suitable amount to achieve the desired degree of milk protein modification under the chosen reaction conditions. The enzyme may be added at a concentration of between 0.0001 and 1 g/L milk substrate, preferably between 0.01 and 0.1 g/L milk substrate.

The enzymatic treatment in the process of the invention may be conducted by adding the enzyme to the milk substrate and allowing the enzyme reaction to take place at an appropriate holding-time at an appropriate temperature. The enzyme treatment may be carried out at conditions chosen to suit the selected protein modifying enzyme according to principles well known in the art. The treatment may also be conducted by contacting the milk substrate with an enzyme that has been immobilised.

The enzyme treatment may be conducted at any suitable pH, such as, e.g., in the range of pH 2-10, such as, at a pH of 4-9 or 5-7. It may be preferred to let the enzyme act at the natural pH of the milk substrate, or, if acidification is obtained because of fermentation, the enzyme may act at the natural pH of the milk substrate during the fermentation process, i.e. the pH will gradually decrease from the natural pH of the unfermented milk substrate to the pH of the fermented milk substrate.

The enzyme treatment may be conducted at any appropriate temperature, e.g. in the range 1-70° C., such as 2-60° C. If the milk substrate is acidified because of fermentation with a microorganism, the enzyme treatment may be conducted during the fermentation, e.g. at 35-45° C.

Optionally, after the enzyme has been allowed to act on the milk substrate, the enzyme protein may be removed, reduced, and/or inactivated by any method known in the art.

Optionally, other ingredients may be added to the acidified milk drink, such as colour; stabilizers, e.g. pectin, starch, modified starch, CMC, etc.; or polyunsaturated fatty acids, e.g. omega-3 fatty acids. Such ingredients may be added at any point during the production process, i.e. before or after acidification, before or after enzyme treatment, and before or after the optional addition of syrup.

In one aspect of the present invention, the dissolved dioxygen concentration of the milk substrate is supplied by at least 10 μM dioxygen, preferably by at least 20 μM, more preferably by at least 30 μM and even more preferably by at least 40 μM dioxygen before or during step b).

The dissolved dioxygen concentration of the milk substrate may be supplied by any method known in the art. It may be supplied directly, e.g., by bubbling, or it may be supplied indirectly, e.g., by adding hydrogen peroxide together with an enzyme having catalase activity.

In the context of the present invention, when the dissolved dioxygen concentration of the milk substrate is supplied by at least 10 μM dioxygen, what is meant is that the dissolved dioxygen concentration is actively increased to be at least 10 μM higher than the dissolved dioxygen concentration under the same conditions without actively increasing the amount of dioxygen.

The dissolved dioxygen concentration of the milk substrate may be increased prior to or at the same time as the treatment with the enzyme having phenoloxidase activity.

In another aspect of the present invention, the dissolved dioxygen level of the milk substrate is increased by at least 5%. Preferably, the dissolved dioxygen level is increased by at least 10%, more preferably by at least 15% and even more preferably by at least 20%.

In another aspect of the present invention, the dissolved dioxygen level of the milk substrate is supplied by at least 5% of the saturated dioxygen level in milk at 25° C., preferably by at least 10%, more preferably by at least 15% and even more preferably by at least 20% of the saturated dioxygen level in milk at 25° C.

The dissolved dioxygen concentration of the milk substrate is the amount of dioxygen found in the solution. It may be measured in milligrams per liter of substrate (mg/l), in micromolar (μM), parts per million of dioxygen to water (ppm) or an equivalent unit. It depends on various factors, such as temperature, pressure, and the amounts of various dissolved or suspended solids in the milk substrate. It can be measured with a dissolved dioxygen probe such as a dioxygen sensor.

The dissolved dioxygen level is a relative measure of the amount of dioxygen that is dissolved or carried in the substrate. It may be calculated as the percentage of dissolved dioxygen concentration in the milk substrate relative to that when the milk substrate is completely saturated at the same temperature and the same pressure.

Percent saturation is calculated by dividing the measured dissolved dioxygen concentration by the saturated dioxygen concentration under the same conditions and multiplying by 100.

In the context of the present invention, when the dissolved dioxygen level of the milk substrate is increased by at least 5%, what is meant is that the dissolved dioxygen level has been actively increased to be at least 5% higher than the dissolved dioxygen level under the same conditions without actively increasing the amount of dioxygen.

The dissolved dioxygen level of the milk substrate may be actively increased by any method known in the art. It may, e.g., be increased by bubbling or by adding hydrogen peroxide together with an enzyme having catalase activity.

The dissolved dioxygen level of the milk substrate may be increased prior to or at the same time as the treatment with the enzyme having phenoloxidase activity.

### Enzyme Having Phenol Oxidase Activity

In the method of the present invention, an enzyme having phenol oxidase activity is used in the production of acidified milk drinks, thus decreasing the syneresis upon storage.

In a preferred embodiment, the enzyme is purified. In another preferred embodiment, the enzyme is extracellular.

In the context of the present invention, an enzyme having phenol oxidase activity may be an enzyme which uses oxygen as an electron acceptor to catalyse the oxidation of phenolic compounds, i.e. any compound which contains a six-membered aromatic ring, bonded directly to at least one hydroxyl group (—OH).

Enzymes having phenol oxidase activity according to the present invention include, e.g., tyrosinase, catechol oxidase, laccase, etc. In a preferred aspect, the enzyme is a tyrosinase.

A tyrosinase according to the present invention is an enzyme which oxidizes tyrosine side chains in peptides/proteins and thereby possibly promotes crosslinking, e.g. to other peptides/proteins. A tyrosinase according to the invention may catalyze the o-hydroxylation of monophenols (phenol molecules in which the benzene ring contains a single hydroxyl substituent) to o-diphenols (phenol molecules containing two hydroxyl substituents) and further possibly catalyze the oxidation of o-diphenols to produce o-quinones.

Without wishing to be bound by any theory, tyrosinase is thus capable of oxidising tyrosine residues in proteins to the corresponding quinones, which may further react with, e.g., free sulfhydryl and/or amino groups resulting in formation of tyrosine-cysteine and tyrosine-lysine cross-links. Quinones have also been suggested to form tyrosine-tyrosine linkages by coupling together.

A tyrosinase according to the invention may also be referred to as, e.g., phenolase, monophenol oxidase, cresolase, catechol oxidase, polyphenolase, pyrocatechol oxidase, dopa oxidase, chlorogenic oxidase, catecholase, polyphenol oxidase, monophenolase, o-diphenol oxidase, chlorogenic acid oxidase, diphenol oxidase, o-diphenolase, tyrosine-dopa oxidase, o-diphenol:oxygen oxidoreductase, polyaromatic oxidase, monophenol monooxidase, o-diphenol oxidoreductase, monophenol dihydroxyphenylalanine:oxygen oxidoreductase, N-acetyl-6-hydroxytryptophan oxidase, monophenol dihydroxy-L-phenylalanine oxygen oxidoreductase, o-diphenol:O₂ oxidoreductase. The group of tyrosinases comprises but is not limited to the enzymes assigned to subclass EC 1.14.18.1.

A catechol oxidase according to the present invention may be a copper protein which catalyses the oxidation of a catechol or a substituted catechol to the corresponding quinone. Such an enzyme may also be referred to as, e.g., diphenol oxidase, o-diphenolase, phenolase, polyphenol oxidase, tyrosinase, pyrocatechol oxidase, Dopa oxidase, catecholase, o-diphenol:oxygen oxidoreductase, o-diphenol oxidoreductase. The group of catechol oxidases comprises but is not limited to the enzymes assigned to subclass EC 1.10.3.1.

A laccase according to the present invention may be a multi-copper protein of low specificity acting on both o- and p-quinols, and often acting also on aminophenols and phenylenediamine. The semiquinone may react further either enzymically or non-enzymically. Such an enzyme may also be referred to as, e.g., urishiol oxidase, urushiol oxidase, or p-diphenol oxidase. The group of laccases comprises but is not limited to the enzymes assigned to subclass EC 1.10.3.2.

Enzymes having phenol oxidase activity to be used in the method of the present invention may be of animal, of plant or of microbial origin. Preferred enzymes are obtained from microbial sources, in particular from a filamentous fungus or yeast, or from a bacterium.

The enzyme may, e.g., be derived from a strain of Agaricus, e.g. A. bisporus; Ascovaginospora; Aspergillus, e.g. A. niger, A. awamori, A. foetidus, A. japonicus, A. oryzae; Chaetomium; Chaetotomastia; Dictyostelium, e.g. D. discoideum; Mucor, e.g. M. javanicus, M. mucedo, M. subtilissimus; Neurospora, e.g. N. crassa; Rhizomucor, e.g. R. pusillus; Rhizopus, e.g. R. arrhizus, R. japonicus, R. stolonifer; Sclerotinia, e.g. S. libertiana; Trichophyton, e.g. T. rubrum; Whetzelinia, e.g. W. sclerotiorum; Bacillus, e.g. B. megaterium, B. subtilis, B. pumilus, B. stearothermophilus, B. thuringiensis; Chryseobacterium; Citrobacter, e.g. C. freundii; Enterobacter, e.g. E. aerogenes, E. cloacae Edwardsiella, E. tarda; Erwinia, e.g. E. herbicola; Escherichia, e.g. E. coli; Klebsiella, e.g. K. pneumoniae; Miriococcum; Myrothesium; Mucor; Neurospora, e.g. N. crassa; Proteus, e.g. P. vulgaris; Providencia, e.g. P. stuartii; Pycnoporus, e.g. Pycnoporus cinnabarinus, Pycnoporus sanguineus; Salmonella, e.g. S. typhimurium; Serratia, e.g. S. liquefasciens, S. marcescens; Shigella, e.g. S. flexneri; Streptomyces, e.g. S. antibioticus, S. castaneoglobisporus, S. violeceoruber; Trametes; Trichoderma, e.g. T. reesei, T. viride; Yersinia, e.g. Y. enterocolitica.

In a preferred embodiment, the enzyme is a tyrosinase from a fungus, e.g. an ascomycete from the class Dothideomycetes, such as from the order Familiae incertae sedis, such as from the family Botryosphaeriaceae, such as from a strain of Botryosphaeria, such as B. obtusa. A preferred enzyme is a tyrosinase having a sequence which is at least 50%, such as at least 60%, at least 70%, at least 80% or at least 90% identical to SEQ ID NO: 1 or to a tyrosinase active fragment thereof. Such tyrosinase active fragment of SEQ ID NO: 1 may be any fragment of SEQ ID NO: 1 having tyrosinase activity. A tyrosinase active fragment of SEQ ID NO: 1 may be, e.g., amino acids 23 to 392 or amino acids 34 to 402 of SEQ ID NO: 1.

In another preferred embodiment, the enzyme is a tyrosinase from a Trichoderma species. Another preferred enzyme is a tyrosinase having at least 50%, such as at least 60%, at least 70%, at least 80% or at least 90% identity to SEQ ID NO: 2 or SEQ ID NO: 3, or to a tyrosinase active fragment of any of these. Such tyrosinase active fragment of SEQ ID NO: 2 may be any fragment of SEQ ID NO: 2 having tyrosinase activity. A tyrosinase active fragment of SEQ ID NO: 2 may be, e.g., amino acids 37 to 434 of SEQ ID NO: 2. Likewise, a tyrosinase active fragment of SEQ ID NO: 3 may be any fragment of SEQ ID NO: 3 having tyrosinase activity. A tyrosinase active fragment of SEQ ID NO: 3 may be, e.g., amino acids 19 to 410 of SEQ ID NO: 3.

Tyrosinases to be used in the method of the present invention may be extracellular. They may have a signal sequence at their N-terminus, which is cleaved off during secretion. Further processing of the tyrosinase during secretion is also possible. In other words, the tyrosinase is produced intracellularly as an immature protein, which may not be enzymatically active. During secretion, the tyrosinase is processed into a smaller protein, which may be referred to as the mature tyrosinase.

In a preferred embodiment, the tyrosinase to be used in the method of the present invention is processed by proteolytic cleavage of the C-terminus. In a more preferred embodiment, the C-terminal proteolytic cleavage activates the tyrosinase, meaning that the mature tyrosinase after the C-terminal processing is more active than the unprocessed enzyme.

The C-terminal proteolytic cleavage may be performed by any suitable protease. It may be a protease expressed by the same cell as the tyrosinase is expressed from, or it may be a protease which is exogenous to the cells expressing the tyrosinase.

In the context of the present invention, an ‘exogenous’ enzyme means an enzyme which is produced or originating outside of an organism or a specific cell or cell line. The protease may be a protease present in the milk substrate, e.g. plasmin. Or it may be a protease which is added to the tyrosinase to activate it prior to its use in the method of the invention. In a preferred embodiment, the tyrosinase is encoded by a gene which has been modified so that the tyrosinase comprises a cleavage site for a specific protease. Such specific protease may be a protease which has little activity on the proteins naturally occurring in the milk substrate. It may be, e.g., thrombin, Factor Xa protease or 3C protease from human rhinovirus.

A tyrosinase to be used according to the invention may be in the unprocessed form, in the mature form, in the activated form, or in any intermediate form, but it comprises at least the part of the protein that is needed for tyrosinase activity. “A tyrosinase active fragment” in the context of the present invention means a part of an amino acid sequence which has tyrosinase activity.

Tyrosinase activity may be determined by any method generally known in the art. L-Dopa or tyrosine can be used as a substrate, where after dopachrome formation may be monitored spectrophotometrically, or alternatively substrate consumption may be monitored by following the oxygen consumption. Tyrosinase activity can also be visualized on agar plates by adding an appropriate substrate such as tyrosine, whereby tyrosinase activity results in a dark zone around the colony.

In a preferred aspect of the method of the invention, the tyrosinase is processed by a protease before or during its use for treatment of the milk substrate, and the processing increases the activity of the tyrosinase. In another preferred embodiment, such protease is exogenous to the cells expressing the tyrosinase. In still another preferred embodiment, the tyrosinase is encoded by a gene which has been modified so that the tyrosinase comprises a cleavage site which is specific for the protease.

### Example 1

### SKMP Solution (Skim Milk Powder)

20 ml water+4.5 g skim milk powder (instant dispersibility from Kerry, Ireland) was incubated at 50° C. for 10 min before use, so a homogeneous solution was obtained.

### Sugar Solution

3.3 g sucrose
10.5 g glucose

These sugars were added to 46 ml 20 mM lactic acid buffer, pH 4.0 and incubated at 90° C. for 5 min with stirring and then cooled down to 5° C.

Sugar Solution with Pectin
3.3 g sucrose
0.225 g pectin (Geno pectin YM-1,5-I from CP Kelco)
10.5 g glucose

These sugars were added to 46 ml 20 mM lactic acid buffer, pH 4.0 and incubated at 90° C. for 5 min with stirring and then cooled down to 5° C.

### Enzyme

A tyrosinase gene from Botryosphaeria obtusa had been cloned into a strain of Aspergillus oryzae. Tyrosinase was purified from this strain to a concentration of 2.5 mg/ml. The tyrosinase was expressed in a form of about 60 kDa, but SDS-PAGE showed that it had at least partly been processed to about 40-45 kDa.

Procedure A (Enzyme Added before Pasteurization)

250 ul SKMP solution was transferred to eppendorf tubes. 20 ul Enzyme or water (control) was added and incubation was performed for 120 min at 50° C.

The solution was incubated at 85° C. for 30 min with 1000 rpm and hereafter incubated at 43° C. for 10 min with 1000 rpm.

30 ul 4 U/I YF-3331 (mixed strain culture containing Streptococcus thermophilus and Lactobacillus delbrueckii subsp. bulgaricus from Chr. Hansen NS, Denmark) was added and incubation was performed for 16 hours at 43° C.

Hereafter the samples were incubated at 0-5° C. ice/water bath for 20 min.

600 ul sugar solution with or without pectin (ice bath) was added and sucked up and down with a pipette five times.

500 ul glass beads (diam. 2 mm, Z273627, Aldrich) (5° C.) were added to each tube.

The samples were placed in an eppendorf thermomixer at 5° C. with 1400 rpm for 10 min.

The samples were placed at 5° C. for 4 days and syneresis was measured.

Procedure B (Enzyme Added after Pasteurization)

250 ul SKMP solution was transferred to eppendorf tubes and incubated for 120 min at 50° C. The solution was incubated at 85° C. for 30 min with 1000 rpm and hereafter incubated at 43° C. for 10 min with 1000 rpm.

30 ul 4 U/I YF-3331 (mixed strain culture containing Streptococcus thermophilus and Lactobacillus delbrueckii subsp. bulgaricus from Chr. Hansen NS, Denmark)+20 ul Enzyme or water (control) was added and incubation was performed for 16 hours at 43° C.

Hereafter the samples were incubated at 0-5° C. ice/water bath for 20 min.

600 ul sugar solution with or without pectin (ice bath) was added and sucked up and down with a pipette five times.

500 ul glass beads (diam. 2 mm, Z273627, Aldrich) (5° C.) were added to each tube.

The samples were placed in an eppendorf thermomixer at 5° C. with 1400 rpm for 10 min.

The samples were placed at 5° C. for 4 days and syneresis was measured.

The data in Table 1 and Table 2 (double determinations) show a decreased syneresis when tyrosinase is added compared to the water control. The most predominant effect can be seen when the enzyme is added before pasteurization.

TABLE 1

| | | | Average | deviation |
|---|---|---|---|---|
| | | | syneresis | (+/−) |
| | Tyrosinase | Pectin | mm | mm |
| Procedure A | | | | |
| Before pasteurization | + | − | 2.8 | 0.1 |
| Water control | − | − | 4.3 | 0.2 |
| Pectin control | − | + | 1.8 | 0.3 |
| Procedure B | | | | |
| After pasteurization | + | − | 4.0 | 0.0 |
| Water control | − | − | 5.5 | 0.5 |
| Pectin control | − | + | 1.5 | 0.1 |

TABLE 2

| | | | Average | deviation |
|---|---|---|---|---|
| | | | syneresis | (+/−) |
| | Tyrosinase | Pectin | mm | mm |
| Procedure A | | | | |
| Before pasteurization | + | − | 1.4 | 0.2 |
| Water control | − | − | 3.1 | 0.4 |
| Pectin control | − | + | 1.8 | 0.2 |
| Procedure B | | | | |
| After pasteurization | + | − | 1.8 | 0.4 |
| Water control | − | − | 2.6 | 0.2 |
| Pectin control | − | + | 1.8 | 0.1 |

1-16. (canceled)

17. A method for producing an acidified milk drink, said method comprising:
a) acidifying a milk substrate comprising milk protein; and
b) treating with an enzyme having phenol oxidase activity;
wherein step b) is performed before, during or after step a).

18. The method of claim 17, wherein step a) comprises fermentation with a microorganism.

19. The method of claim 17, wherein step a) comprises chemical acidification.

20. The method of claim 17, wherein step b) is performed before or during step a).

21. The method of claim 17, wherein the milk substrate is subjected to pasteurization before step a) and step b) is performed before pasteurization.

22. The method of claim 17, wherein the dissolved dioxygen concentration of the milk substrate is supplied by at least 10 μM dioxygen before or during step b).

23. The method of claim 17, wherein the acidified milk substrate is mixed with a syrup and the mixture is subjected to homogenization.

24. The method of claim 17, wherein the acidified milk drink is consumed as a beverage.

25. The method of claim 17, wherein the acidified milk drink has a viscosity of less than 40 Pa at a shear rate of 300 pr·s.

26. The method of claim 17, wherein the milk substrate has a protein content of more than 5%.

27. The method of claim 17, wherein the milk substrate has a lactose content of more than 7%.

28. The method of claim 17, wherein the acidified milk drink has a milk solid non-fat content of less than 8%.

29. The method of claim 17, wherein the enzyme is a tyrosinase.

30. The method of claim 29, wherein the tyrosinase is processed by a protease before or during its use for treatment of the milk substrate, and wherein the processing increases the activity of the tyrosinase.

31. The method of claim 17, wherein the enzyme is a tyrosinase having at least 70% identity to SEQ ID NO: 1, SEQ ID NO: 2 or SEQ ID NO: 3, or to a tyrosinase active fragment of any of these.

32. An acidified milk drink obtainable by the method of claim 17.


SEQUENCE LISTING (3 sequences)

SEQ ID NO: 1 - protein, 547 aa, Botryosphaeria obtusa
MRLFDISAALGALCLFSLGANASPIEPGLVERQSSFFALTGAGGGTSPRLEVRDLAANADQWNLFLLAMQRFQSKPQANKLSYYQVAGIHGRPYVNWDGVAAYTSQPYWPGYCPHSSNLFGTWHRPYISLFEQLVLQYANEIINESPAGATKTKYQTAVKTLRFPFWDWAKKTSSVIPGPLSQATVRVTFPQNGTSTSIPNPVYAYRFQVVPDPNFDGSYANNRQTLRSSSAEANLQASYTSRRNTLLTLFSRNQAYNTFSTDANGNTAPNLEGIHNGVHNDIGGYMQQIAYSAMDPIFAMHHANVDRIVAIWQKLYPNSYVAAASQAAGTRTIAPGTSRDANSPLTPFHRDTGGTFWTSNTVRDTTVLGYTYPDLVGVSNSQLTTNLNRLYGNTATNTALRVTGTGDTSATTYDYMAMVTLDKSVLGGMSYAVRFLLNGQYFASFAALAVPQPPGGQTKAVTSSGTVMLTAALAERGVDTSDREATEQYLSENLKWQVVQNDQVVNNVPSLNVTIASTEVKPAKATNQFATWLGPPQEIDNSTSSS

SEQ ID NO: 2 - protein, 623 aa, Trichoderma species
MGFLARLTWVFHLVLLLVAAQDYDFGVDVISITRRRDTDAPIVVGRLPSASNGSTPLRLEIRDVKADKYRWDLYILALSMFQSVNQDDPLSYYQVAGIHGVPFVTWNGVGPAAGASQSGYCPHSSVLFPTWHRPYLALYEQELHKLAGAIADMFANATERFLYRQAASDFRIPYWDWASPAPEGESHFPDVFWNSTMIQYGPNGVQVIRNPLYSYSFHPLDGDALIWPPLRSWNETKRAPNTEISQAEPPSMNDQVSAALLARLPEIQQRLYILFSSYHEFDSFSNKNYAFSQNLSHLDSIEAVHDIIHIYGGSRGHMTYVPLSSFDPLFFLHHAMTDRLISMWQLLNPSAWMTPQISGETTYTALKGTMQNSSTPLTPFMSSADGTFWDSDMSRSTEVFGYAYGDTSYVPGDSESPRNKLIRKINRWLGLNSPAMVRIKSQAQNRRPSGVWKGNTGVKGVQPSLKIDMSDVVDDHYTEWIANVHVNHGALDGSFSIYFFAGKPPADVGTWAFAPNLMGSVGIFTMSGMGGHHSKMSGSVPLTMALMRLASLGAVQSVEPNSVVAFLQSRLHFRIASIDDKEIDPSLVAGLFIGISSTRVRLPKSELEFPDWGQPMLRLVLWE

SEQ ID NO: 3 - protein, 571 aa, Trichoderma species
MLLSASLSALALATVSLAQGTTHIPVTGVPVSPGAAVPLRQNINDLAKSGPQWDLYVQAMYNMSKMDSHDPYSFFQIAGIHGAPYIEYNKAGAKSGDGWLGYCPHGEDLFISWHRPYVLLFEQALVSVAKGIANSYPPSVRAKYQAAAASLRAPYWDWAADSSVPAVTVPQTLKINVPSGSSTKTVDYTNPLKTYYFPRMSLTGSYGEFTGGGNDHTVRCAASKQSYPATANSNLAARPYKSWILVTDTESGPQYDVLTNSQNFADFASTSGPGINVEQIHNAIHWDGACGSQFLAPDYSGFDPLFFMHHAQVDRMWAFWEAIMPSSPLFTASYKGQSRFNSKSGSTITPDSPLQPFYQANGKFHTSNTVKSIQGMGYSYQGIEYWQKSQAQIKSSVTTIINQLYGPNSGKKRNAPRDFLSDIVTDVENLIKTRYFAKISVNVTEVTVRPAEINVYVGGQKAGSLIVMKLPAEGTVNGGFTIDNPMQSILHGGLRNAVQAFTEDIEVEILSKDGQAIPLETVPSLSIDLEVANVTLPSALDQLPKYGQRSRHRAKAAQRGHRFAVPHIPPL